(19) United States
(12) Patent Application Publication
(10) Pub. No.: US 2017/0147274 A1
(43) Pub. Date: May 25, 2017

(54) SEPARATION CONTROL VIDEO SYSTEM IN WHICH MOBILE TERMINAL AND HMD DEVICE ARE INDEPENDENTLY SEPARATED AND OPERATING METHOD THEREOF

(71) Applicant: WiseJet, Inc., Daejeon (KR)

(72) Inventors: InnYeal OH, Daejeon (KR); SyeungIl KIM, Yongin-si (KR); ByeongNam AHN, Yongin-si (KR); ChulSoon PARK, Daejeon (KR)

(73) Assignee: WiseJet, Inc., Daejeon (KR)

(21) Appl. No.: 15/203,745

(22) Filed: Jul. 6, 2016

(30) Foreign Application Priority Data
Nov. 19, 2015 (KR) 10-2015-0162554

(51) Int. Cl. G06F 3/14; G09G 5/12; G06F 3/0346

(52) U.S. Cl. CPC G06F 3/1454; G06F 3/0346; G09G 5/12; G09G 2354/00; G09G 2370/16; G09G 2370/06

(57) ABSTRACT

Disclosed are a separation control video system in which a mobile terminal and an HMD device are independently separated from each other to control a direction of the image and an operating method thereof. The HMD device senses a spatial recognition data through a spatial sensor and transmits an image control data calculated based on the spatial recognition data to the mobile terminal and the mobile terminal extracts a controlled image corresponding to the image control data from an original image and transmits the controlled image to the HMD device.

### BACKGROUND OF THE INVENTION

1. Field of the Invention

The present invention relates to a separation control video system and an operating method thereof, and more particularly, to a separation control video system in which a mobile terminal and an HMD device are independently separated from each other to control a direction of an image.

2. Description of the Related Art

A head mounted display (HMD) device is worn on a head like glasses to allow a user to enjoy a video and is a video display device which may be used in operation or diagnosis. The video display device may be classified into an HMD device into which a smart phone or a mobile terminal can be inserted or an HMD device based on a PC or a desktop computer.

Korea Patent Registration No. 0800859 is a technique applying a structure in which a smart phone is inserted into an HMD device, and there is a problem in that the HMD device is heavy and heat is generated due to power consumption of the smart phone.

U.S. Pat. No. 9,063,330 is a technique of controlling an HMD by using a PC which controls an image and user's motion. The user's motion is limited due to a wire connected between the PC and the HMD and contents are limited, and thus only HMD-dedicated contents may be used and there is no mobility by using the PC.

### SUMMARY OF THE INVENTION

The present invention has been made in an effort to provide a separation control video system in which a mobile terminal and an HMD device are independently separated from each other without a wire to control a direction of an image and reduce the HMD device in weight,

An exemplary embodiment of the present invention provides a separation control video system in which a mobile terminal and a head mounted display (HMD) device are independently separated from each other to control a direction of an image, in which the HMD device senses a spatial recognition data through a spatial sensor and transmits an image control data sensed and calculated based on the spatial recognition data to the mobile terminal, and the mobile terminal extracts a controlled image corresponding to the image control data from an original image and transmits the controlled image to the HMD device.

Another exemplary embodiment of the present invention provides an HMD device receiving a controlled image by connecting a mobile terminal, including: a sensor unit which senses a spatial recognition data for a user's motion through a spatial sensor; a coordinate conversion unit which converts the spatial recognition data into a 2D coordinate data; a HMD communication unit which transmits an image control data for the 2D coordinate data to the mobile terminal and receives a controlled image corresponding to the image control data from the mobile terminal; a display unit which displays the controlled image; and a HMD controller which controls transmission and reception of the image control data and the controlled image and controls reproduction of the controlled image.

Yet another exemplary embodiment of the present invention provides a mobile terminal which receives an image control data by connecting an HMD device including: a communication unit which receives an image control data sensed based on a spatial recognition data from the HMD device and transmits a controlled image corresponding to the image control data to the HMD device; an image extraction unit which extracts the controlled image corresponding to the image control data from an original image; and a controller which controls the image control data to be recognized as 2D input data and controls transmission and reception of the controlled image and the image control data.

Still another exemplary embodiment of the present invention provides an operating method of an HMD device receiving a controlled image by connecting a mobile terminal including: sensing a spatial recognition data for a user's motion through a spatial sensor of the HMD device; converting the spatial recognition data into a 2D coordinate data; transmitting an image control data for the 2D coordinate data to the mobile terminal and receiving a controlled image corresponding to the image control data from the mobile terminal; and displaying the controlled image.

Still yet another exemplary embodiment of the present invention provides an operating method of a mobile terminal which receives an image control data by connecting an HMD device including: receiving an image control data sensed based on a spatial recognition data from the HMD device; extracting a controlled image corresponding to the image control data from an original image; and transmitting the controlled image to the HMD device.

### BRIEF DESCRIPTION OF THE DRAWINGS

FIG. 1 is a block diagram illustrating a separation control video system of the present invention.

FIG. 2 is a block diagram illustrating an HMD device which receives a controlled image by connecting a mobile terminal of the present invention.

FIG. 3 is a block diagram illustrating a mobile terminal which receives an image control data by connecting an HMD device of the present invention.

FIG. 4 is a flowchart illustrating an operating method of the separation control video system of the present invention.

FIG. 5 is a flowchart illustrating an operating method of an HMD device which receives a controlled image by connecting a mobile terminal of the present invention.

FIG. 6 is a flowchart illustrating an operating method of a mobile terminal which receives an image control data by connecting an HMD device of the present invention.

### DETAILED DESCRIPTION OF THE PREFERRED EMBODIMENTS

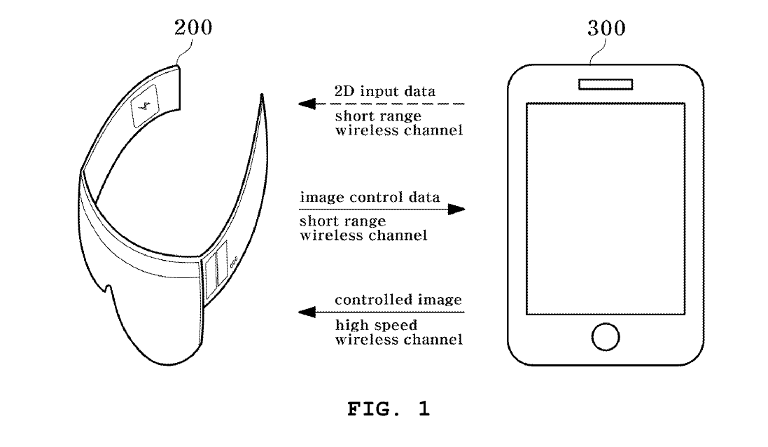

FIG. 1 is a block diagram illustrating a separation control video system of the present invention, and the separation control video system includes a head mounted display (HMD) device 200 and a mobile terminal 300.

In prior art HMD, an input device or a controller is wiredly connected to limit the user's motion and hinder immersion. In the separation control video system of the present invention, the mobile terminal 300 and the HMD device 200 are independently functioned and wirelessly connected if necessary to control an HMD image.

The HMD device 200 senses a spatial recognition data through a spatial sensor and transmits an image control data calculated based on the spatial recognition data to the mobile terminal 300.

The mobile terminal 300 includes a human interface device (HID) which recognizes 2D input data by at least on of a touch pad, a stylus pen, a radio pen, a button key, a virtual key, a wired mouse, a wireless mouse, and a joystick.

The HMD device 200 converts the spatial recognition data into a 2D coordinate data so that the HID of the mobile terminal 300 may recognize the spatial recognition data to calculate an image control data.

The mobile terminal 300 extracts a controlled image corresponding to the image control data from an original image and transmits the controlled image to the HMD device 200.

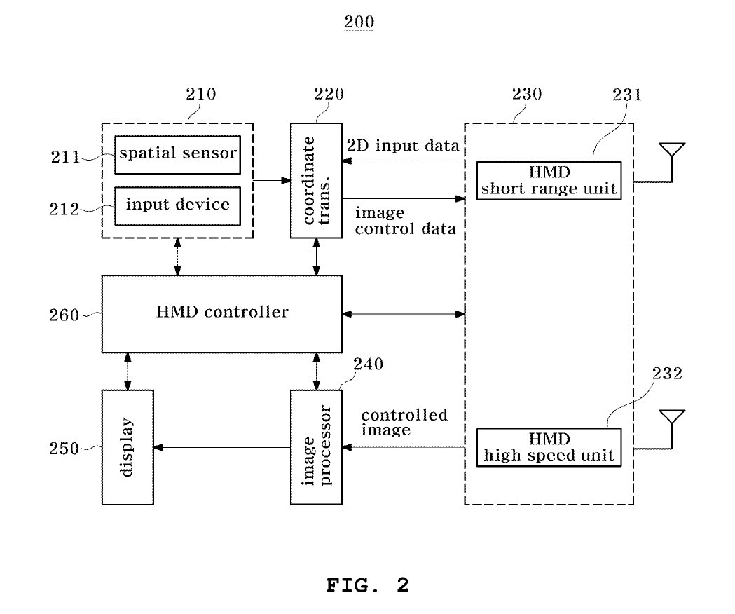

FIG. 2 is a block diagram illustrating an HMD device which receives a controlled image by connecting a mobile terminal of the present invention. The HMD device 200 includes a sensor unit 210, a coordinate conversion unit 220, an HMD communication unit 230, a display unit 250, and an HMD controller 260.

The sensor unit 210 senses the spatial recognition data for the user's motion through a spatial sensor 211.

The spatial sensor 211 may be a sensor which senses a direction and a space of the user's motion, such as a gyroscope or an accelerator. The spatial recognition data sensed by the spatial sensor 211 may be a 3D coordinate value including x, y, and z-axial coordinates.

The coordinate conversion unit 220 converts the spatial recognition data into the 2D coordinate data to calculate an image control data.

The mobile terminal includes the HID which recognizes at least one of a touch pad, a stylus pen, a radio pen, a button key, a virtual key, a wired mouse, a wireless mouse, and a joystick, and thus the coordinate conversion unit 220 converts a 3D coordinate value into the 2D coordinate data so as to be recognized by the mobile terminal.

The sensor unit 210 may receive an input data corresponding to a selection input of the user by an input device 212.

The input data may be a value for the selection input of the user for at least one of a touch pad, a stylus pen, a radio pen, a button key, a virtual key, a wired mouse, a wireless mouse, and a joystick which are included in the HMD device 200. For example, the selection input of the user may be an input for a 2D direction including left, right, up, and down.

The HMD communication unit 230 includes an HMD short-range wireless unit 211 and an HMD high-speed wireless unit 212.

The HMD short-range wireless unit 211 transmits the image control data to the mobile terminal and the HMD high-speed wireless unit 212 receives the controlled image corresponding to the image control data from the mobile terminal.

The HMD short-range wireless unit 211 transmits the image control data to the mobile terminal by using a short-range wireless channel and the HMD high-speed wireless unit 212 receives the controlled image corresponding to the image control data from the mobile terminal by using a high-speed wireless channel.

The short-range wireless channel may be a communication channel such as Bluetooth technology, WiFi technology, and Zigbee technology, and the high-speed wireless channel may be a wireless channel of a GHz or THz band which has a larger transmission speed than the short-range wireless channel and accommodates giga-bits.

The display unit 250 displays the controlled image and the HMD controller 260 controls transmission and reception of the image control data and the controlled image and controls reproduction of the controlled image.

The HMD controller 260 may control transmission and reception of the image control data and the controlled image through a device driver or a micro controller and control the reproduction of the high-definition controlled image.

The mobile terminal includes the HID which recognizes at least one of a touch pad, a stylus pen, a radio pen, a button key, a virtual key, a wired mouse, a wireless mouse, and a joystick, and the HMD short-range wireless unit 211 may receive the 2D input data by using the short-range wireless channel.

The HMD device 200 may further include an image processing unit 240 which processes the 2D input data to be reflected to the controlled image, and the HMD controller 260 may control a direction of the displayed image through the controlled image based on the 2D input data.

The separation control video system of the present invention may include the sensor unit 210 or the HID which senses the selection input of the user in the HMD device 200 or the mobile terminal and perform bidirectional communication between the HMD device 200 and the mobile terminal through the short-range wireless channel.

The mobile terminal controls the space or the direction of the image based on the spatial recognition data, and the HMD device 200 may control the image space or the operation of the mobile terminal based on the input data.

Further, the mobile terminal may control the image space or the operation of the HMD device 330 based on the 2D input data.

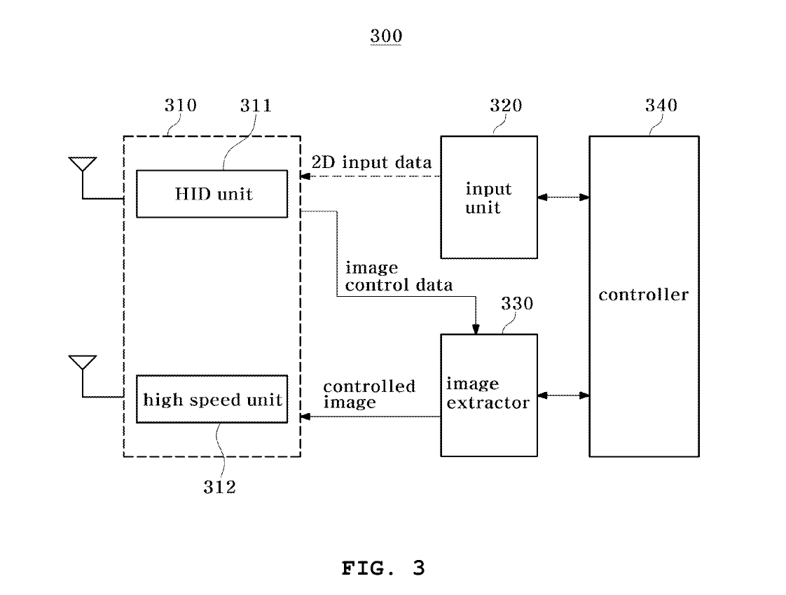

FIG. 3 is a block diagram illustrating a mobile terminal which receives an image control data by connecting an HMD device of the present invention, and the mobile terminal includes a communication unit 310, an image extraction unit 330, and a controller 340.

The communication unit 310 includes an HID communication unit 311 and a high-speed wireless unit 312, and the HID communication unit 311 corresponds to the HMD short-range wireless unit of the HMD device to perform the communication, and the high-speed wireless unit 312 corresponds to the high-speed unit of the HMD device to perform the communication.

The HID communication unit 311 receives the image control data calculated based on the spatial recognition data from the HMD device. According to the exemplary embodiment, the HID communication unit 311 may include the HID which recognizes the 2D input data described in FIG. 2 and for example, the HID communication unit 311 may recognize a Bluetooth device as the HID.

In the separation control video system, the HMD device and the mobile terminal 300 may include a separate device which recognizes the 2D input data.

The image extraction unit 330 extracts the controlled image corresponding to the image control data from an original image.

The image extraction unit 330 may extract the user selection image or the controlled image according to the motion from the image information in response to the image control data including the spatial recognition data or the spatial coordinate data for the user's motion.

Further, the image extraction unit 330 may extract the controlled image reflecting the selection input of the user from the original image in response to the image control data including the input data by the selection input of the user.

The high-speed wireless unit 312 transmits the controlled image corresponding to the image control data to the HMD device. More particularly, the high-speed wireless unit 312 may transmit the controlled image corresponding to the image control data to the HMD device by using the high-speed wireless channel.

The controller 340 controls the image control data as the 2D input data and controls the transmission and reception of the control value and the image control data.

Further, the controller 340 may control the image space based on the spatial recognition data or the input sensing value.

The mobile terminal 300 may be driven based on an application or a framework, and the controller 340 may control the image control data as the 2D input data through an ARM processor and control the transmission and reception of the control value and the image control data.

The mobile terminal 300 may further include an input unit 320 which senses 2D input data by at least on of a touch pad, a stylus pen, a radio pen, a button key, a virtual key, a wired mouse, a wireless mouse, and a joystick.

The HID communication unit 311 may recognize the 2D input data to transmit the recognized 2D input data to the HMD device, and the HMD device may reflect the 2D input data to the controlled image to display the reflected controlled image as illustrated in FIG. 2.

In the channels formed between the HMD device 200 and the mobile terminal 300, the short-range wireless channel may provide bidirectional communication and the high-speed channel may provide unidirectional communication.

In the separation control video system of the present invention, the mobile terminal and the HMD device 200 are independently separated from each other without a separate wire to control the direction of the image. Thus, the entire weight of the HMD device 200 is reduced, the limitation for the display quality of the mobile terminal 300 may not be received, the heat generation of the HMD device 200 may be minimized, and the separation control video system may be used as an open type platform.

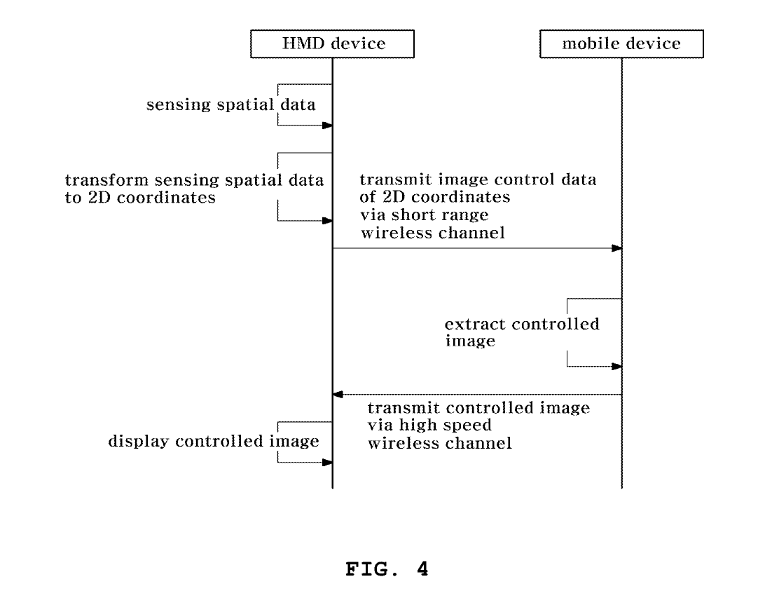

FIG. 4 is a flowchart illustrating an operating method of the separation control video system of the present invention. In the separation control video system, the HDM device senses the spatial recognition data through the spatial sensor and converts the spatial recognition data into the 2D coordinate data to calculate the image control data.

The HMD device 200 converts the spatial recognition data into the 2D coordinate data so that the HID of the mobile terminal 300 may recognize the spatial recognition data to calculate the image control data.

The image control data may further include an input data by the selection input of the user.

In the separation control video system, the HDM device transmits the image control data to the mobile terminal through the short-range wireless channel and the mobile terminal extracts the controlled image corresponding to the image control data from the original image.

The mobile terminal may extract the user selection image or the controlled image according to the motion from the original image in response to the image control data including the spatial recognition data or the spatial coordinate data for the user's motion.

Further, the mobile terminal may extract the controlled image reflecting the selection input of the user from the original image in response to the image control data including the input sensing value by the selection input of the user.

In the separation control video system, the mobile terminal transmits the controlled image through the high-speed wireless channel and the HMD device displays the controlled image.

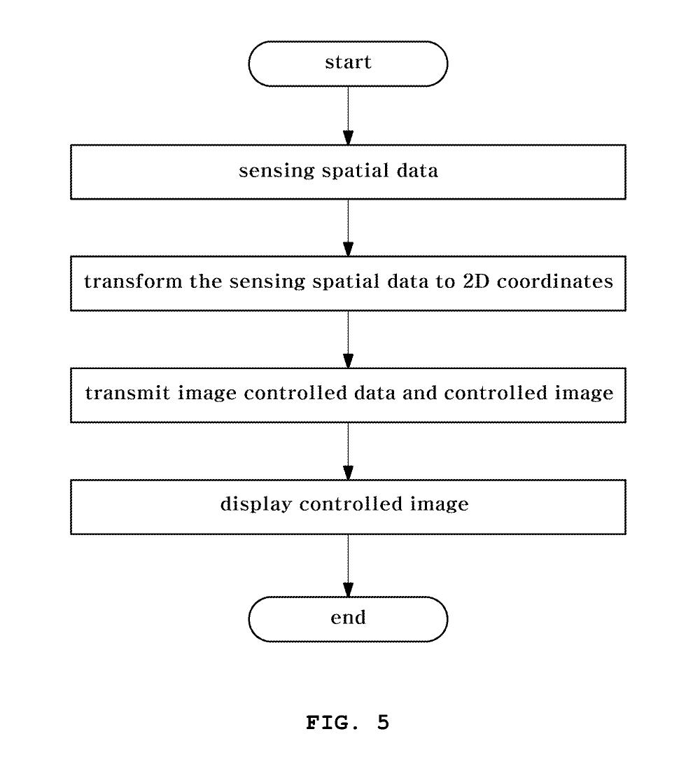

FIG. 5 is a flowchart illustrating an operating method of an HMD device which receives a controlled image by connecting a mobile terminal of the present invention.

Referring to FIG. 5, the HMD device senses the spatial recognition data for the user's motion through the spatial sensor, converts the spatial recognition data into the 2D coordinate data to calculate the image control data, transmits the image control data to the mobile terminal, receives the controlled image corresponding to the image control data from the mobile terminal, and displays the controlled image.

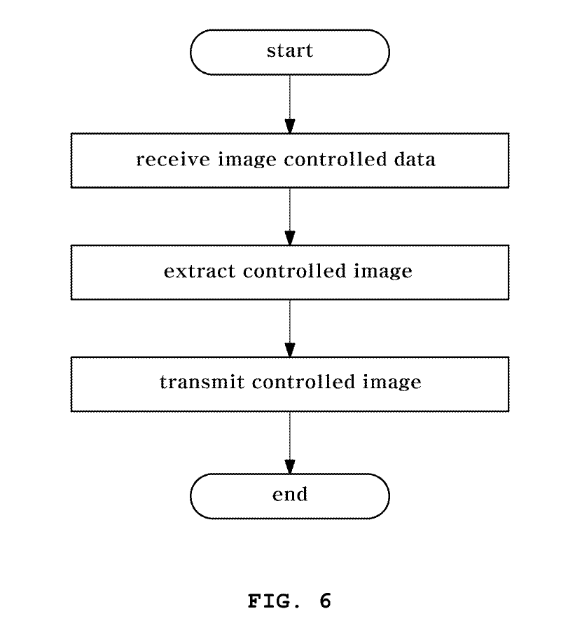

FIG. 6 is a flowchart illustrating an operating method of a mobile terminal which receives an image control data by connecting an HMD device of the present invention.

Referring to FIG. 6, the mobile terminal receives the image control data sensed based on the spatial recognition data from the HMD device, extracts the controlled image corresponding to the image control data from the original image, and transmits the controlled image to the HMD device.

What is claimed is:

1. A separation control video system in which a mobile terminal and a head mounted display (HMD) device are independently separated from each other to control a direction of an image, wherein
the HMD device senses a spatial recognition data through a spatial sensor and transmits an image control data sensed and calculated based on the spatial recognition data to the mobile terminal, and
the mobile terminal extracts a controlled image corresponding to the image control data from an original image and transmits the controlled image to the HMD device.

2. The separation control video system of claim 1, wherein the HMD device transmits an image control data which further includes an input data input through an input device to the mobile terminal.

3. The separation control video system of claim 1, wherein the HMD device converts the spatial recognition data into a 2D coordinate data to calculate an image control data.

4. The separation control video system of claim 1, wherein the mobile terminal receives the image control data from the HMD device by using a short-range wireless channel and transmits a controlled image to the HMD device by using a high-speed wireless channel.

5. The separation control video system of claim 1, wherein the mobile terminal includes a human interface device (HID) which recognizes 2D input data by at least on of a touch pad, a stylus pen, a radio pen, a button key, a virtual key, a wired mouse, a wireless mouse, and a joystick.

6. The separation control video system of claim 5, wherein the HID receives and recognizes the image control data from the HMD device.

7. The separation control video system of claim 5, wherein the HID transmits the 2D input data to the HMD device, and the HMD device controls a direction of the image displayed through the controlled image based on the 2D input data.

8. The separation control video system of claim 2, wherein the mobile terminal controls an image space based on the spatial recognition data, and the HMD device controls the image space or the operation of the mobile terminal based on the input sensing value.

9. A HMD device receiving a controlled image by connecting a mobile terminal, comprising:
a sensor unit which senses a spatial recognition data for a user's motion through a spatial sensor;
a coordinate conversion unit which converts the spatial recognition data into a 2D coordinate data;
a HMD communication unit which transmits an image control data for the 2D coordinate data to the mobile terminal and receives a controlled image corresponding to the image control data from the mobile terminal;
a display unit which displays the controlled image; and
a HMD controller which controls transmission and reception of the image control data and the controlled image and controls reproduction of the controlled image.

10. A mobile terminal which receives an image control data by connecting an HMD device, comprising:
a communication unit which receives an image control data sensed based on a spatial recognition data from the HMD device and transmits a controlled image corresponding to the image control data to the HMD device;
an image extraction unit which extracts the controlled image corresponding to the image control data from an original image; and
a controller which controls the image control data to be recognized as 2D input data and controls transmission and reception of the controlled image and the image control data.

11. An operating method of an HMD device receiving a controlled image by connecting a mobile terminal, comprising:
sensing a spatial recognition data for a user's motion through a spatial sensor of the HMD device;
converting the spatial recognition data into a 2D coordinate data;
transmitting an image control data for the 2D coordinate data to the mobile terminal and receiving a controlled image corresponding to the image control data from the mobile terminal; and
displaying the controlled image.

12. An operating method of a mobile terminal which receives an image control data by connecting an HMD device, comprising:
receiving an image control data sensed based on a spatial recognition data from the HMD device;
extracting a controlled image corresponding to the image control data from an original image; and
transmitting the controlled image to the HMD device.
